(19) United States
(12) Patent Application Publication
(10) Pub. No.: US 2010/0246166 A1
(43) Pub. Date: Sep. 30, 2010

(54) Illumination apparatus

(76) Inventors: Nien-Hui Hsu, Hukou Township (TW); Wei-Cheng Lo, Hukou Township (TW); Cheng Wang, Hukou Township (TW)

Correspondence Address: MH2 TECHNOLOGY LAW GROUP, LLP, 1951 KIDWELL DRIVE, SUITE 550, TYSONS CORNER, VA, 22182, US

(21) Appl. No.: 12/659,790

(22) Filed: Mar. 22, 2010

(30) Foreign Application Priority Data
Mar. 24, 2009 (TW) 098109516

(51) Int. Cl. F21L 4/02; F21V 29/00; F21L 4/00

(52) U.S. Cl. 362/184; 362/373; 362/157

(57) ABSTRACT

An illumination apparatus includes a housing, a light source, a centrifugal fan, and a heat sink. The housing has an accommodation, a plurality of inlets, and a plurality of outlets. The accommodation communicates with the outside of the housing through the inlets and the outlets. The light source, the centrifugal fan, and the heat sink are disposed in the accommodation. The heat sink includes a base and a plurality of fins connected to the base. The base is connected to the light source, the fins radially surround the centrifugal fan. An air channel is disposed between two adjacent fins. An air from the outside of the housing is capable of flowing into the accommodation through the inlets and then into the centrifugal fan in an axial direction of the centrifugal fan, and flow out of the accommodation in a radial direction of the centrifugal fan through the air channel and outlets.

### CROSS-REFERENCE TO RELATED APPLICATION

This applications claims the priority benefit of Taiwan application serial no. 98109516, filed on Mar. 24, 2009. The entirety of the above-mentioned patent application is hereby incorporated by reference herein and made a part of this specification.

### BACKGROUND OF THE INVENTION

1. Field of the Invention

The invention relates to an illumination apparatus, and more particularly to an illumination apparatus having good heat dissipation efficiency.

2. Description of Related Art

Recently, since the light brightness and light efficiency of the light emitting diode (LED) are improved persistently, and the white light LED having high brightness is mass manufactured successfully, so that the white light LED is gradually used in illumination apparatus, such as indoor illumination or outdoor road lamp illumination. However, the high power LED has a problem of heat dissipation. If the LED operates in an over-high temperature, the brightness of the light beam generated by the LED may be reduced, and the life of the LED may be shortened.

Two conventional methods are used to solve the heat dissipation problems. One method uses a heat sink to contact with the LED source, so that the heat sink is capable of dissipating the heat generated inside the illumination apparatus by natural convection. However, the method is adapted to a low power LED illumination apparatus for the low heat dissipation efficiency. Besides, another method further includes an axial fan in the base of the above method.

FIG. 1 is a schematic diagram of a conventional illumination apparatus. Referring to FIG. 1, the illumination apparatus 100 includes a light source 110, a heat sink 120, an axial fan 130, and a power source 140. As an air flow direction shown in FIG. 1, since the air flows into the axial fan 130 from one side of the axial fan 130, and the axial fan 130 is disposed between the light source 110 and the power source 140, so that the air flows out of the axial fan 130 may be blocked and may not flow smoothly.

Besides, the flow field of the axial fan 130 is turbulent flow, and the arrangement direction of the axial fan 130 and the fins of the heat sink 120 may not be parallel, so that the flow quality of the air out of the axial fan decreases due to the flow resistance of the air increased, thus, the air from the outside flowed into the illumination apparatus 100 may not be successfully discharged by the axial fan 130, and then, the heat generated by the illumination apparatus 100 is accumulated inside the illumination apparatus 100.

### SUMMARY OF THE INVENTION

Accordingly, the invention provides an illumination apparatus having good heat dissipation efficiency.

Other advantages of the present invention should be further indicated by the disclosures of the present invention, and omitted herein for simplicity.

To achieve at least one of the above-mentioned advantages, an embodiment of the invention provides an illumination apparatus including a housing, a light source, a centrifugal fan, and a heat sink. The housing has an accommodation, a plurality of inlets, and a plurality of outlets, wherein the accommodation communicates with the outside of the housing through the inlets and the outlets. The light source, the centrifugal fan, and the heat sink are disposed in the accommodation. The heat sink includes a base and a plurality of fins connected to the base, wherein the base is connected to the light source and the fins radially surrounds the centrifugal fan. An air channel is disposed between two adjacent fins, and an air from the outside of the housing is capable of flowing into the accommodation through the inlets and then into the centrifugal fan in an axial direction of the centrifugal fan, and flowing out of the accommodation in a radial direction of the centrifugal fan through the air channel and the outlets.

In one embodiment of the invention, the illumination apparatus further includes a power supply disposed in the accommodation, wherein the centrifugal fan and the heat sink are disposed between the power supply and the light source, and the power supply is electrically coupled to the light source and the centrifugal fan. The power supply further includes a first circuit board, and the first circuit board has a plurality of first openings, and wherein a part of the air flowing into the accommodation from the inlet is capable of flowing into the centrifugal fan through the first openings.

In one embodiment of the invention, the illumination apparatus further includes a connector disposed on one side of the housing, the side of the housing is opposite to the accommodation, and the connector is electrically coupled to the power supply.

In one embodiment of the invention, the housing includes a lamp cover, a first housing, and a second housing. The lamp cover covers the light source, and the first housing receives the power supply. The second housing is connected between the lamp cover and the first housing so as to make the second housing, the lamp cover, and the first housing form the accommodation. The second housing surrounds the centrifugal fan and the heat sink, wherein the inlets are disposed at the lamp cover and the first housing respectively, and the outlets are disposed at the second housing.

In one embodiment of the invention, the lamp cover has a plurality of shielding portions adjacent to the inlets for preventing impurities from entering the accommodation through the inlets.

In one embodiment of the invention, the light source includes a second circuit board, and the second circuit board has a plurality of second openings, wherein a part of the air flowing into the accommodation from the inlets is capable of flowing into the centrifugal fan through the second openings.

In one embodiment of the invention, the base has a plurality of third openings, wherein a part of the air flowing into the accommodation from the inlets is capable of flowing into the centrifugal fan through the third openings.

In one embodiment of the invention, the fins are a straight radiate shape or an airfoil radiate shape.

In one embodiment of the invention, the light source includes a plurality of light emitting diodes

In summary, the embodiment or the embodiments of the invention may have at least one of the following advantages. The illumination apparatus has the centrifugal fan and the heat sink, and the fins of the heat sink are radiate in the radial direction of the centrifugal fan, so that the heat dissipation efficiency of the illumination apparatus is improved. In other words, the operating temperature of the light source may be controlled in a permitted range so as to increase the life of the illumination apparatus.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a conventional illumination apparatus.

FIG. 2 is a schematic diagram of an illumination apparatus according to one embodiment of the invention.

FIG. 3 is a top view of a centrifugal fan and a heat sink of the illumination apparatus of FIG. 2.

FIG. 4 is a partial top view of a centrifugal fan and a heat sink of the illumination apparatus according to another embodiment of the invention.

FIG. 5 is a partial cross-sectional diagram of an inlet of the lamp cover according to the illumination apparatus in FIG. 2.

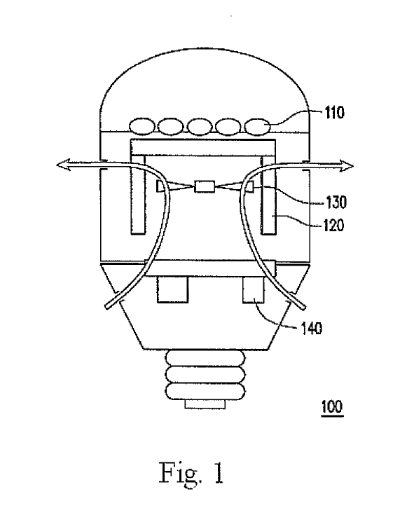

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

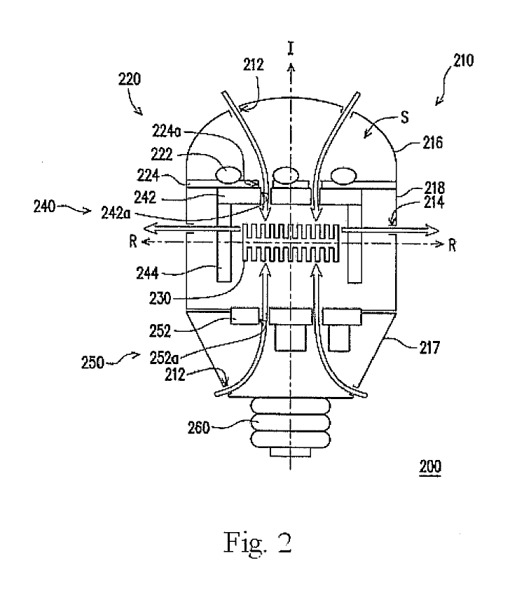

Referring to FIG. 2, an illumination apparatus 200 includes a housing 210, a light source 220, a centrifugal fan 230, and a heat sink 240. The housing 210 has a accommodation S, a plurality of inlets 212, and a plurality of outlets 214, wherein the accommodation S communicates with the outside of the housing 210 through the inlets 212 and the outlets 214. The light source 220, the centrifugal fan 230, and the heat sink 240 are disposed in the accommodation S. The heat sink 240 includes a base 242 and a plurality of fins 244 connected to the base 242, wherein the base 242 is connected to the light source 220 to dissipate the heat generated by the light source 220 through the fins 244.

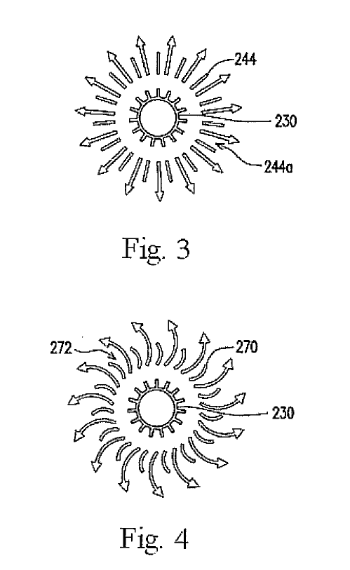

Referring to FIG. 2 and FIG. 3, in the embodiment, the fins 244 are a straight radiate shape and surround the centrifugal fan 230. An air channel 244a is disposed between two adjacent fins 244. When the centrifugal fan 230 operates, the air from the outside of the housing 210 is capable of flowing into the accommodation S through the inlets 212 and then flowing into the centrifugal fan 230 along an axial direction I of the centrifugal fan 230, and flowing out of the accommodation S in a radial direction R of the centrifugal fan 230 through the air channel 244a and the outlets 214, so that dissipate the heat.

In the illumination apparatus 200 of the embodiment, since the centrifugal fan 230, the fins 244 radially disposed in the radial direction of the centrifugal fan 230, and the inlets 212 and the outlets 214 of the housing may form a circular flow field in the accommodation S of the illumination apparatus 200, so that the air may continually flow between the accommodation S and the outside of the accommodation S. Thus, the heat generated by the illumination apparatus 200 is continually dissipated out of the accommodation S by the natural convection when the illumination apparatus 200 operates. Consequently, the illumination apparatus 200 has good heat dissipation efficiency, and the lighting power and the life of the illumination apparatus 200 are increased.

Referring to FIG. 2, the illumination apparatus 200 further includes a power supply 250 and a connector 260, wherein the power supply 250 is disposed in the accommodation S, and the connector 260 is disposed on one side of the housing 210 opposite to the accommodation S. The connector 260 is electrically coupled to the power supply 250 to transfer the power of outside to the power supply 250. For example, the power supply 250 is a transformer or a commutator electrically coupled to the light source 220 and the centrifugal fan 230 to transform the outside power to a power adapted to the light source 220 and the centrifugal fan 230.

Moreover, the power supply 250 further includes a first circuit board 252, the first circuit board 252 has a plurality of first openings 252a, wherein a part of the air flowing into the accommodation S from the inlets 212 is capable of flowing into the centrifugal fan 230 through the first openings 252a.

The light source 220 includes a plurality of light emitting diodes (LEDs) 222 and a second circuit board 224. In the embodiment, the LEDs 222 are distributing on the second circuit board 224. The second circuit board 224 has a plurality of second openings 224a, and the base 242 of the heat sink 240 has a plurality of third openings 242a. Similar to the first openings 252a, a part of the air flowing from the inlets 212 is capable of flowing into the centrifugal fan 230 through the second openings 224a and the third openings 242a in sequent.

As described above, since the centrifugal fan 230 and the heat sink 240 are disposed between the light source 220 and the power supply, and the first openings 252a and the second openings 224a are disposed on the first circuit board 252 and the second circuit board 224 respectively, the air flowing from the inlets 212 is capable of flowing into the centrifugal fan 230 through the openings. A flow field inside the accommodation S is formed by the outside air, and the flow field is adapted to the operation of the centrifugal fan 230, so that the heat generated by the light source 220 and the power supply 250 is dissipated to the centrifugal fan 230 by the flow field. Generally, the centrifugal fan 230 includes a top cover, a bottom cover, and centrifugal leaves disposed between the top cover and the bottom cover, in the embodiment of the invention, the air receiving function of the top cover and the bottom cover of the centrifugal fan 230 is replaced by the first circuit board 252 and the second circuit board 224, so that the centrifugal fan 230 of the invention may be centrifugal leaves to reduce the weight and the cost.

Referring to FIG. 3, in the embodiment of the invention, the fins 244 surround the centrifugal fan 230 and are radially disposed in the radial direction R of the centrifugal fan 230 so as to complete the flow field inside the accommodation S, so that the air may communicate with the accommodation S and the outside of the accommodation S and be continually circulating. Since the extending direction of the fin 244 is the same as the air outputting direction of the centrifugal fan 230, the air flowing out in the radial direction R of the centrifugal fan 230 may flow out the accommodation S through the outlet 214 along the air channel 244a having the same direction as the radial direction R of the centrifugal fan 230. Thus, a circular flow field is completed and the air flowing out of the centrifugal fan 230 may have a flowing direction. As a result, the heat transferred from the light source 220 to the fins 244 is dissipated outside of the accommodation S by the circular flow field, thus, the heat is dissipated.

Referring to FIG. 4, the difference from the above embodiments is described as following. The fins 270 of the heat sink are an airfoil radiate shape. The tilted arrangement of the fins 270 makes the air smoothly flow through the air channel 272 between the fins 270 in a direction of the flow field.

Referring to FIG. 2, in the embodiment, the housing 210 of the illumination apparatus 200 includes a lamp cover 216, a first housing 217, and a second housing 218. The lamp cover 216 covers the light source 220, the first housing 217 receives the power supply 250, and the inlets 212 are disposed on the lamp cover 216 and the first housing 217. The second housing 218 is connected with the lamp cover 216 and the first housing 217 to form the accommodation S. The second housing 218 surrounds the centrifugal fan 230 and the heat sink 240, and the second housing 218 has the outlets 214.

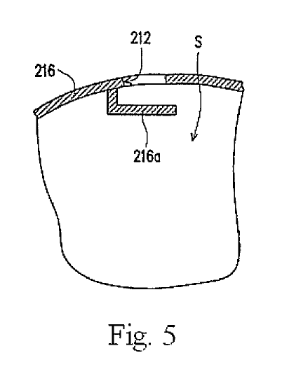

Referring to FIG. 5, in the embodiment, the lamp cover 216 has a plurality of shielding portions 216a adjacent to the inlets 212 in the accommodation S. In other embodiments, the shielding portions 216a may be disposed out of the accommodation S. The shielding portion 216a is capable of preventing impurities from entering the accommodation S, for example, preventing the dust entering the illumination apparatus 200, or preventing the bugs entering the illumination apparatus 200 due to the phototaxis.

In summary, the embodiment or the embodiments of the invention may have at least one of the following advantages. The centrifugal fan of the illumination apparatus makes the air flow into the centrifugal fan from both sides of the centrifugal fan along the axial direction of the centrifugal fan, wherein the air is flowing from the inlet to the accommodation. Besides, the fins surround the centrifugal fan and are radially disposed in a radial direction, so that, the air from the centrifugal fan may flow out of the accommodation through the air channel and the outlets. Thus, a flow field having double direction to inlet and double direction to outlet is formed in the accommodation, so that, the air may continually circulate between the illumination apparatus and the outside of the illumination apparatus to decrease the operating temperature of the illumination apparatus, and consequently to increase the light efficiency and the life of the illumination apparatus.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An illumination apparatus, comprising:
a housing, having an accommodation, a plurality of inlets, and a plurality of outlets, wherein the accommodation communicates with the outside of the housing through the inlets and the outlets;
a light source, disposed in the accommodation;
a centrifugal fan, disposed in the accommodation; and
a heat sink, disposed in the accommodation, the heat sink comprising a base and a plurality of fins connected to the base, wherein the base is connected to the light source, the fins radially surround the centrifugal fan, an air channel is disposed between two adjacent fins, and the inlets and the centrifugal fan are arranged so that an air from the outside of the housing is capable of flowing into the accommodation through the inlets and then into the centrifugal fan in an axial direction of the centrifugal fan, and flowing out of the accommodation in a radial direction of the centrifugal fan through the air channel and the outlets.

2. The illumination apparatus as claimed in claim 1, further comprising a power supply disposed in the accommodation, wherein the centrifugal fan and the heat sink are disposed between the power supply and the light source, and the power supply is electrically coupled to the light source and the centrifugal fan.

3. The illumination apparatus as claimed in claim 2, further comprising a connector disposed on one side of the housing, the side of the housing being opposite to the accommodation, and the connector being electrically coupled to the power supply.

4. The illumination apparatus as claimed in claim 2, wherein the power supply comprises a first circuit board, and the first circuit board has a plurality of first openings, and wherein a part of the air flowing into the accommodation from the inlets is capable of flowing into the centrifugal fan through the first openings.

5. The illumination apparatus as claimed in claim 2, wherein the housing comprises:
a lamp cover, covering the light source;
a first housing, receiving the power supply; and
a second housing, being connected between the lamp cover and the first housing so as to make the second housing, the lamp cover, and the first housing form the accommodation, the second housing surrounding the centrifugal fan and the heat sink, wherein the inlets are disposed at the lamp cover and the first housing respectively, and the outlets are disposed at the second housing.

6. The illumination apparatus as claimed in claim 5, wherein the lamp cover has a plurality of shielding portions adjacent to the inlets for preventing impurities from entering the accommodation through the inlets.

7. The illumination apparatus as claimed in claim 1, wherein the light source comprises a second circuit board, and the second circuit board has a plurality of second openings, and wherein a part of the air flowing into the accommodation from the inlets is capable of flowing into the centrifugal fan through the second openings.

8. The illumination apparatus as claimed in claim 1, wherein the base has a plurality of third openings, and wherein a part of the air flowing into the accommodation from the inlets is capable of flowing into the centrifugal fan through the third openings.

9. The illumination apparatus as claimed in claim 1, wherein the fins are a straight radiate shape.

10. The illumination apparatus as claimed in claim 1, wherein the fins are an airfoil radiate shape.

11. The illumination apparatus as claimed in claim 1, wherein the light source comprises a plurality of light emitting diodes.
